(19) United States
(12) Patent Application Publication
(10) Pub. No.: US 2015/0120346 A1
(43) Pub. Date: Apr. 30, 2015

(54) Clustering-Based Learning Asset Categorization and Consolidation

(71) Applicant: International Business Machines Corporation, Armonk, NY (US)

(72) Inventors: Brian P. Byrne, Austin, TX (US); Ivan M. Milman, Austin, TX (US); Martin A. Oberhofer, Bondorf (DE); Sushain Pandit, Austin, TX (US)

(73) Assignee: International Business Machines Corporation, Armonk, NY (US)

(21) Appl. No.: 14/066,873

(22) Filed: Oct. 30, 2013

(51) Int. Cl. G06Q 10/06

(52) U.S. Cl. CPC G06Q 10/063
USPC 705/7.11

(57) ABSTRACT

A mechanism is provided in a data processing system for categorization of assets. The mechanism receives attribute values for a set of information technology (IT) assets. The mechanism performs k-means clustering analysis to cluster together IT assets with similar attributes to form a set of asset clusters. The mechanism uses a knowledge representation associated with the set of IT assets to assign the IT assets into a set of tentative clusters. The mechanism categorizes the set of IT assets into categories based on a combination of the set of asset clusters and the set of tentative clusters.

### BACKGROUND

The present application relates generally to an improved data processing apparatus and method and more specifically to mechanisms for clustering-based asset categorization and consolidation.

Information technology (IT) is the application of computers and telecommunications equipment to store, retrieve, transmit and manipulate data, often in the context of a business or other enterprise. The term is commonly used as a synonym for computers and computer networks, but it also encompasses other information distribution technologies such as television and telephones. Several industries are associated with information technology, such as computer hardware, software, electronics, semiconductors, internet, telecom equipment, e-commerce and computer services.

### SUMMARY

in one illustrative embodiment, a method, in a data processing system, is provided for categorization of assets. The method comprises receiving attribute values for a set of information technology (IT) assets. The method further comprises performing k-means clustering analysis to cluster together IT assets with similar attributes to form a set of asset clusters. The method further comprises using a knowledge representation associated with the set of assets to assign the IT assets into a set of tentative clusters. The method further comprises categorizing the set of IT assets into categories based on a combination of the set of asset clusters and the set of tentative clusters.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system apparatus is provided. The system apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a block diagram illustrating a mechanism for asset categorization and consolidation in accordance with an illustrative embodiment;

FIGS. 4 and 5 depict example screens of display from an architecture modeling tool in accordance with an illustrative embodiment;

FIG. 6 is a block diagram illustrating a mechanism for categorizing a new asset in accordance with an illustrative embodiment;

FIG. 7 is a block diagram illustrating a mechanism for mapping a new requirement in accordance with an illustrative embodiment;

FIG. 8 is a flowchart illustrating operation of a mechanism for asset categorization and consolidation in accordance with an illustrative embodiment;

FIG. 9 is a flowchart illustrating operation of a mechanism for categorizing a new asset in accordance with an illustrative embodiment; and

FIG. 10 is a flowchart illustrating operation of a mechanism for mapping a new requirement in accordance with an illustrative embodiment.

### DETAILED DESCRIPTION

The illustrative embodiments provide a clustering-based approach to learning asset categorization and consolidation. In today's information landscape, new information assets (e.g., databases, servers, data sources, workstations, reports, Extract, Transform and Load (ETL) jobs, routines, etc.) keep surfacing as information architectures and underlying designs change over time. Often, enterprises grow organically and inherit a large number of new, duplicated, or potentially replaceable assets. Similarly, in cases where a scale down of a sub-organization occurs, enterprises may lose information assets, potentially having been replaced through new projects or acquisitions.

In face of such unpredictable and non-traceable growth, consolidation of existing assets to make sense of what exists in the information landscape and classification of newly acquired assets become key issues. There is lack of a mechanism to consolidate across existing assets, without requiring a detailed point-in-time analysis of the entire landscape. Further, there is no way to compute a representative pattern (abstraction over the entire landscape), which could be used to quickly characterize a new or existing asset instead of laboring through a detailed low-level analysis.

Specifically, organizations would like to understand patterns (e.g., geographical or organizational proximity, business relevance, technical relevance, cost effectiveness, etc.), across the information landscape, in order to group similar assets together and evolve asset classes over a period of time. Newly acquired assets could then be classified relative to these classes, which in themselves would be continuously evolving as more knowledge about the landscape is acquired, organized and understood. Similarly, when there is a requirement to be supported, that requirement could be ‘mapped’ to these existing classes or patterns to determine if there is a potential asset resource, which could be reused to fill in that need.

The illustrative embodiments address the problem of automatic asset classification and consolidation through a learning framework. The mechanisms determine clusters of existing assets based on how similar the assets are. These asset dusters or categories are designed in a manner that lets them evolve over time as the system learns more robust patterns of characterization. The mechanisms of the illustrative embodiments provide automatic categorization of newly acquired assets within a constantly evolving asset landscape. The mechanisms of the illustrative embodiments consolidate across existing assets without requiring a detailed point-in-time analysis of the entire landscape. The mechanisms compute a representative pattern (abstraction over the entire landscape), which can be used to quickly characterize a new or existing asset.

The above aspects and advantages of the illustrative embodiments of the present invention will be described in greater detail hereafter with reference to the accompanying figures. It should be appreciated that the figures are only intended to be illustrative of exemplary embodiments of the present invention. The present invention may encompass aspects, embodiments, and modifications to the depicted exemplary embodiments not explicitly shown in the figures but would be readily apparent to those of ordinary skill in the art in view of the present description of the illustrative embodiments.

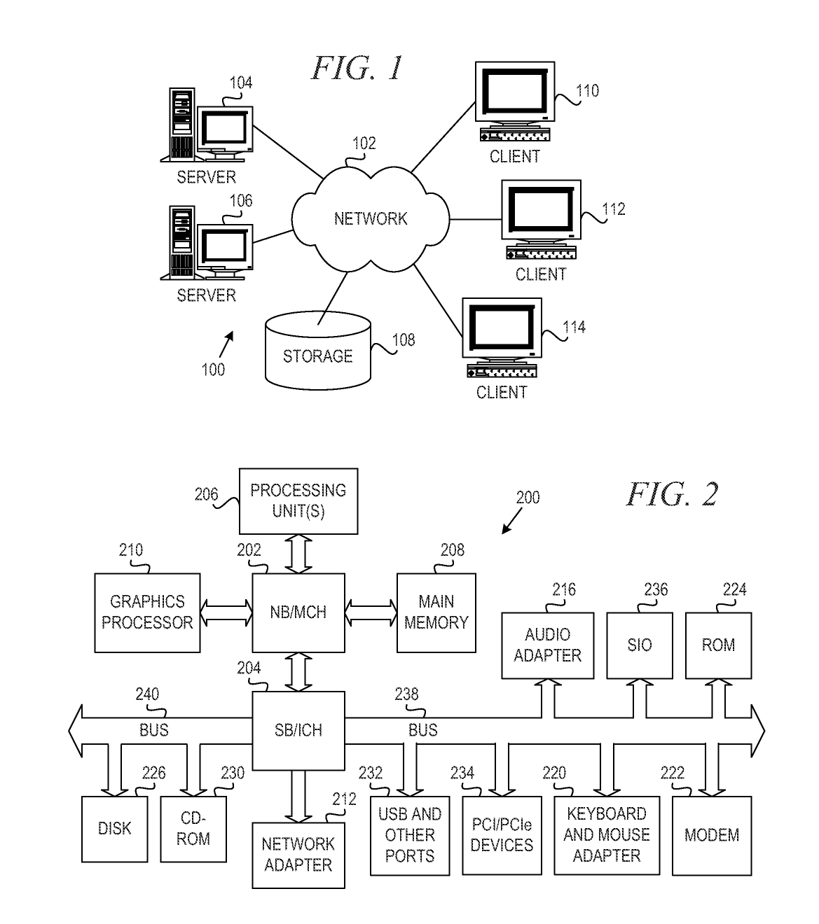

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PC uses a card bus controller, while PCIe does not. ROM 224 may be, for example, a flash basic input/output system (BIOS).

HDD 226 and CD-ROM drive 230 connect to SB/ICH 204 through bus 240, HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows 7®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

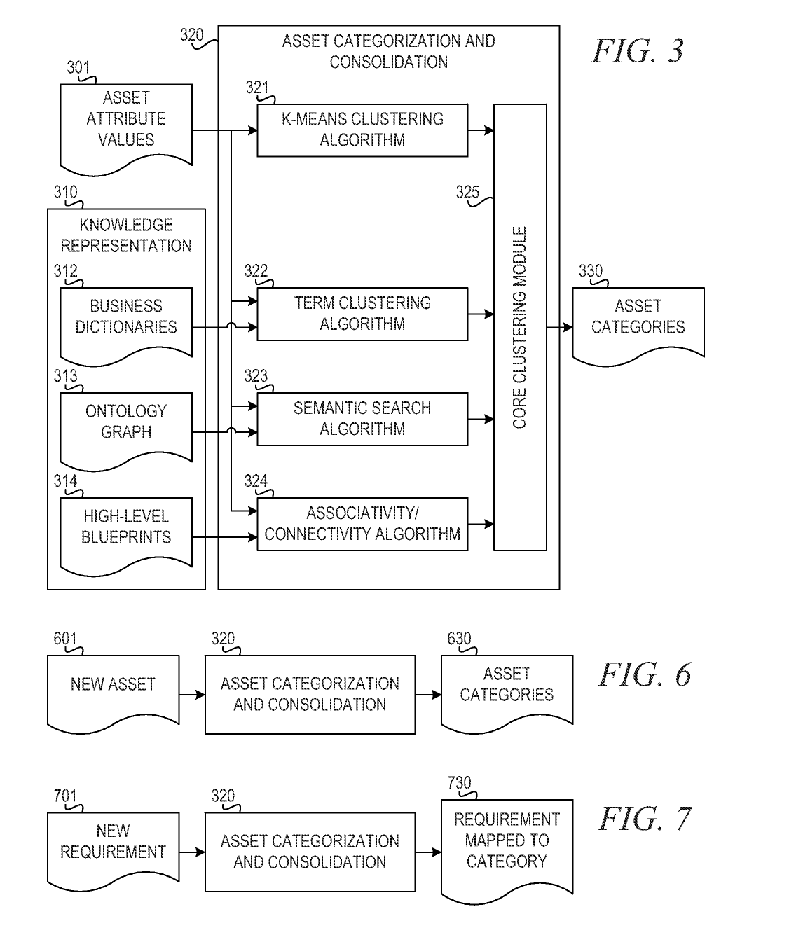

FIG. 3 is a block diagram illustrating a mechanism for asset categorization and consolidation in accordance with an illustrative embodiment. Asset categorization and consolidation system 320 may be embodied as a software product executing on a data processing system, such as server 104 in FIG. 1, for example. Asset categorization and consolidation system 320 performs unsupervised categorization (clustering) of known assets based on various asset attributes or existing knowledge in the information landscape. Asset categorization and consolidation system 320 uses existing clusters to categorize a newly acquired asset by computing its “distance” from existing clusters, using a nearest neighbor or similar) classifier. Asset categorization and consolidation system 320 also uses the existing clusters to map a new requirement and determine if it can be satisfied through existing assets.

Asset categorization and consolidation system 320 receives asset attribute values 301 for all existing assets. One must define the attributes and gather values for the attributes for any asset existing in the information landscape or being added. Asset categorization and consolidation system 320 and uses k-means clustering algorithm 321 to cluster the assets. The k-means clustering algorithm 321 is a method of vector quantization originally from signal processing that is popular for cluster analysis in data mining. The k-means clustering algorithm 321 aims to partition n observations into k clusters in which each observation belongs to the cluster with the nearest mean, serving as a prototype of the cluster.

Given a set of observations (x₁, x₂, . . . xₙ), where each observation is a d-dimensional real vector, k-means clustering aims to partition the n observations into k sets (k≦n) S={S₁, S₂, . . . , Sₖ} so as to minimize the within-cluster sum of squares (WCSS):

$${arg min}_{S} {\sum }_{i = 1}^{k} {\sum }_{{x}_{j} ∈ {S}_{i}}^{ } {‖ {x}_{j} - {μ}_{i} ‖}^{2} ,$$

where μ₁ is the mean of points in Sᵢ.

The most common algorithm uses an iterative refinement technique. Due to its ubiquity, this algorithm is often called the k-means algorithm; it is also referred to as Lloyds algorithm, particularly in the computer science community. Of course, other variations of the k-means clustering algorithm may be used in the illustrative embodiment. Given an initial set of k means in m₁⁽¹⁾, . . . , mₖ⁽¹⁾, the algorithm proceeds by alternating between two steps:

Assignment steps: Assign each observation to the cluster whose mean yields the least within-cluster sum of squares (WCSS). Since the sum of squares is the squared Euclidean distance, this is intuitively the “nearest” mean.

Sᵢ^{(t)}={xₚ:∥xₚ−mᵢ^{(t)}∥²≦∥xₚ−mⱼ^{(t)}∥²∀1≦j≦k},

where each xₚ is assigned to exactly one S^{(t)}, even if it could be is assigned to two or more of them.

Update step: Calculate the new means to be the centroids of the observations in the new clusters.

$${m}_{i}^{( t + 1 )} = \frac{1}{\vert {S}_{i}^{( t )} \vert} {\sum }_{{x}_{j} ∈ {S}_{i}^{( t )}}^{ } {x}_{j}$$

Since the arithmetic mean is a least-squares estimator, this also minimizes the within-cluster sum of squares (WCSS) objective.

The algorithm has converged when the assignments no longer change. Since both steps optimize the objective, and there only exists a finite number of such partitionings, the algorithm must converge to a (local) optimum. There is no guarantee that the global optimum is found using this algorithm.

The algorithm is often presented as assigning objects to the nearest cluster by distance. This is slightly inaccurate: the algorithm aims at minimizing the WCSS objective, and thus assigns by “least sum of squares,” Using a different distance function other than (squared) Euclidean distance may stop the algorithm from converging. It is correct that the smallest Euclidean distance yields the smallest squared Euclidean distance and thus also yields the smallest sum of squares. Various modifications of k-means such as spherical k-means and k-medoids have been proposed to allow using other distance measures.

Commonly used initialization methods are Forgy and Random Partition. The Forgy method randomly chooses k observations from the data set and uses these as the initial means. The Random Partition method first randomly assigns a cluster to each observation and then proceeds to the update step, thus computing the initial mean to be the centroid of the cluster's randomly assigned points. The Forgy method tends to spread the initial means out, while Random Partition places all of them close to the center of the data set.

As the k-means algorithm is a heuristic algorithm, there is no guarantee that it will converge to the global optimum, and the result may depend on the initial clusters. As the algorithm is usually very fast, it is common to run it multiple times with different starting conditions.

Before utilizing k-means clustering algorithm 321, asset categorization and consolidation system 320 defines the notion of a “means” in the current scenario. For this, the system takes into consideration various attributes that define the assets in an information landscape. Subsets of relevant attributes may be selectively used for clustering different types of assets if not everything is applicable in all cases.

For instance, for clustering assets of type “servers,” various server characteristics, e.g., processing/CPU, RAM, page file size, optimization and tuning parameter settings, log file size, various database characteristics (schema, number of tables, triggers, stored procedures, indices and/or views, and so on), are considered. This information is usually discovered through “spider” algorithms used in physical asset discovery and then these asset attributes are stored in a database and available through querying the database. An appropriate mean may be defined by weighing these attributes as per a pre-defined weighing scheme.

Once the means are defined, a standard Lloyd's algorithm is used to compute step updates until convergence. At the end of this process, server assets with similar characteristics are clustered together. Based on this clustering, a representative pattern for each cluster/class is defined (e.g., load balancer pattern, backup server pattern, workstation pattern, etc.). The k-means clustering algorithm 321 may use any combination of initialization and clustering techniques depending on the implementation of the illustrative embodiments.

Asset categorization and consolidation system 320 also uses knowledge representation 310 to augment or validate the clustering. For example, asset categorization and consolidation system 320 uses term clustering algorithm 322 to utilize business dictionaries 312 to determine assets assigned to same/similar terms and mark them in tentative clusters. Core clustering module 325 may then validate these clusters against those found by k-means clustering algorithm 321. In one example embodiment, core clustering module 325 may give more weight to the results of k-means clustering algorithm 321.

In one example, quite a few of T-type assets would be likely mapped to Terms representing the business definition and use of “T.” Term clustering algorithm 322 performs various operations like term semantic equivalence by referring term names and descriptions to determine this initial cluster.

Term clustering algorithm 322 also utilizes existing hierarchies (e.g., term and category hierarchies in business dictionaries 312) to go the next level and tentatively cluster assets even if they are not directly linked to the same term. These clusters are again validated against those found by k-means clustering algorithm 321. Again, term clustering algorithm 322 may give more weight to results from k-means clustering algorithm 321.

Here, term clustering algorithm 322 utilizes semantic similarity algorithms based on a number of hops (edge counts) between terms and/or categories in the hierarchy.

In the above example, there can be a top-level term representing and sub-terms T₁ and T₂ to which respectively n₁ and n₂ assets may be assigned. In this case, depending on an adjustable threshold (determining a cut-off for semantic closeness), the algorithm may end up grouping all the assets assigned to T₁ and T₂ in a single cluster of n₁+n₂ assets and label the cluster as “T.”

Semantic search algorithm 323 utilizes enterprise ontologies in ontology graph 313 to further gauge asset similarity on a deep semantic front. The results from these semantic searches are presented to a user on a user interface (UI) for confirmation, before putting them into one of the clusters determined by k-means clustering algorithm 321 and term clustering algorithm 322.

Semantic matching is a technique used in computer science to identify information which is semantically related. Given any two graph-like structures, e.g., classifications, database or extensible markup language (XML) schemas, and ontologies, matching is an operator that identifies those nodes in the two structures that semantically correspond to one another. For example, applied to file systems, it can identify that a folder labeled “car” is semantically equivalent to another folder “automobile” because they are synonyms.

S-Match is a good example of semantic matching operator. It works on lightweight ontologies, namely graph structures where each node is labeled by a natural language sentence. These sentences are translated into a formal logical formula (according to an artificial unambiguous language codifying the meaning of the node taking into account its position in the graph. For example, in case the folder “car” is under another folder “red” we can say that the meaning of the folder “car” is “red car” in this case. This is translated into the logical formula “red AND car.”

The output of S-Match is a set of semantic correspondences called mappings attached with one of the following semantic relations: disjointness (⊥), equivalence (≡) more specific ( [symbol] ), and less specific ( [symbol] ). Information semantically matched can also be used as a measure of relevance through a mapping of near-term relationships.

Enterprise ontologies have semantic meaning on their edges, which goes above and beyond a simple “is-a” relationship. These relationships are used to perform semantic searches on an ontology graph to determine similarity.

To add to the above example, the enterprise ontology 313 may have two concepts, representing “Datacenter” and “Backup_Server” connected by a semantic relationship, “contains.” “Datacenter” has one instance, called “Datacenter_Austin.” “Backup_Server” has five instances, each corresponding to a distinct backup server in Austin. The five “Backup_Server” instances are related to “Datacenter_Austin” by a “contains” relationship. “Datacenter_Austin” also has a “contains” relationship to two other instances which are of type “Load balancer.” Based on this input, the semantic search algorithm presents these two instances as being “related” to the other five and asks the user for confirmation.

Note that the semantic search algorithm 323 is further refined by core clustering module 325. This core clustering module 323 helps determine additional evidence to accept or reject a candidate for inclusion in a cluster.

In addition, associativity/connectivity algorithm 324 utilizes blueprints/templates to deduce asset similarity based on associativity and connectivity between assets in high-level design blueprint 314. These are presented as suggestions on the UI to the user to semi-automatically add to one of the clusters formed by k-means clustering algorithm 321, term clustering algorithm 322, and semantic search algorithm 323.

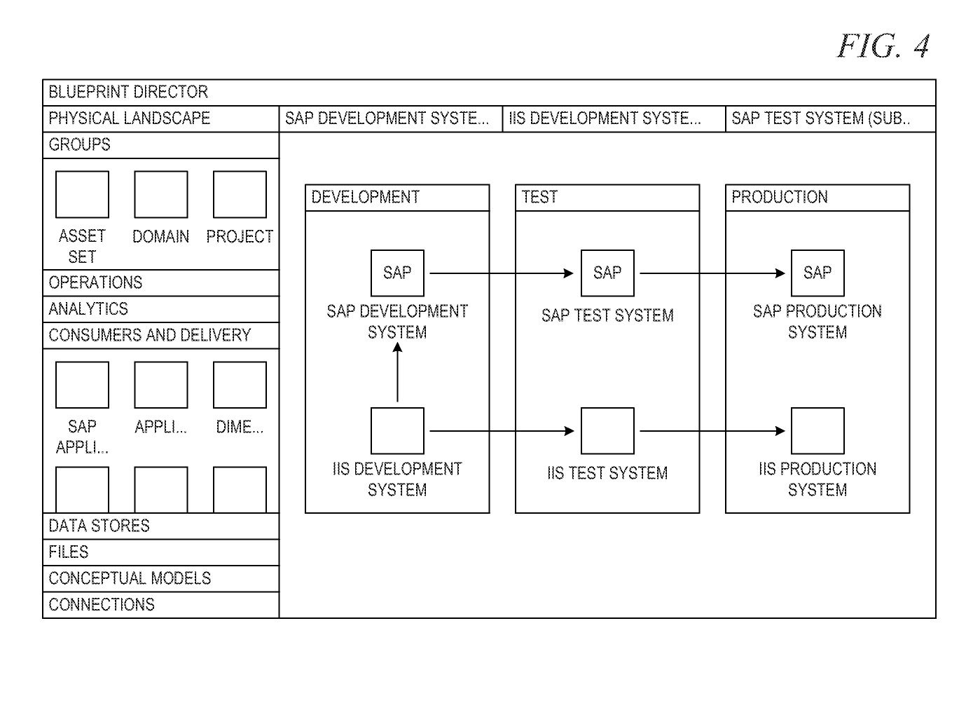

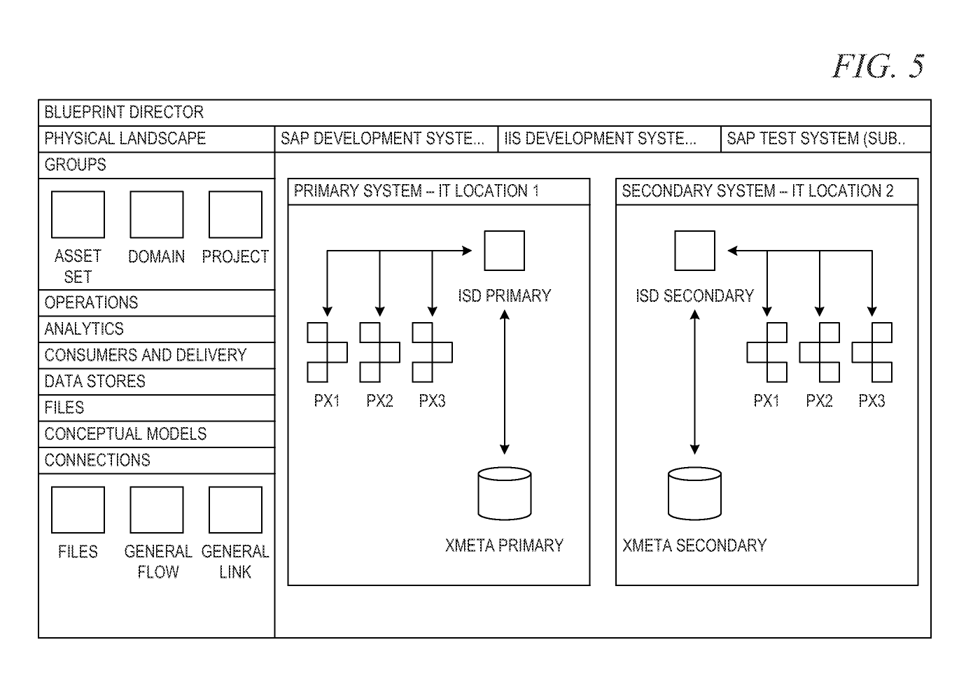

To illustrate this, FIGS. 4 and 5 depict example screens of display from an architecture modeling tool in accordance with an illustrative embodiment. FIG. 4 shows for the ready-to-launch (RTL) solution for SAP® enterprise software, a typical topology of development, test, and production system including how the InfoSphere® Information Server (IIS) code components on the IIS side as well as the generated SAP® code components for IIS are propagated through the environment.

Exploring now more details on the IIS development system leads to FIG. 5 showing that the IIS development system is using an active-active high availability deployment using multiple physical nodes across a primary and secondary data center, XMETA is a metadata database for IIS and is in the primary data center as well as in the secondary data center. Assume the primary data center for this HS deployment is the data center in Austin, which was previously introduced as “Datacenter_Austin.” In accordance with the illustrative embodiments, doing a right-click on the XMETA database in the second figure would allow the user to see a list of the previously introduced five instances of “Backup_Server.”

The Information Architect may then pick the correct backup server for this database, enriching the architecture blueprint information. This is a bottom-up approach. From a top-down approach perspective, the following is possible: As shown in FIG. 5, there are multiple instances of the parallel engine deployed on multiple physical nodes. With just browsing the physical characteristics like central processing unit (CPU), random access memory (RAM), etc., physical location of the asset and software packages deployed it is difficult to know which parallel engine nodes belong together. Browsing the graph and specifically the edges in the architecture blueprint here it is possible to see that three parallel engine nodes are connected to the same IIS software development (ISD) primary node. Therefore, they must belong to the same physical IIS instance.

Similarly, with the edge between the ISD primary and the ISD secondary, it becomes obvious that these two IIS instances, which are located in two different data. centers, belong together and actually form a single unified IIS environment. This information allows improvement of the cluster information in the sense that patterns can be strengthened, in this case combining a set of assets discovered in two data centers into a single asset cluster for IIS. If multiple IIS instances are found within a data center over time discovering these patterns becomes easier and the structure of the pattern sharper. In the IIS case, there is always an XMETA primary and an ISD primary with X numbers of instances of the parallel engine

Core clustering module 325 combines results from k-means clustering algorithm 321, term clustering algorithm 322, semantic search algorithm 323, and associativity/connectivity algorithm 324. Core clustering module 325 receives results from k-means clustering algorithm 321 and augments the results with analysis of asset attribute values 301 based on knowledge representations 310. More specifically, core clustering module 325 combines results of term clustering algorithm 322 with results of k-means clustering algorithm 321, weighting the results to provide more accurate categorization of assets. Core clustering module 325 also augments and validates the clustering with results from semantic search algorithm 323 and associativity connectivity algorithm 324. Core clustering module 325 outputs asset categories 330 based on the combined results of algorithms 321-324.

FIG. 6 is a block diagram illustrating a mechanism for categorizing a new asset in accordance with an illustrative embodiment. If a new asset 601 is installed into the landscape at some information processing node, asset categorization and consolidation system 320 measures the mean of the new asset 601 and determines the cluster with the closest mean. Asset categorization and consolidation system 320 determines which cluster the asset 601 should be placed into in asset categories 630. For example, if new asset 601 is a server, asset categorization and consolidation system 320 may determine whether the server should be categorized as a load balancer, backup server, or workstation. Thus, asset categorization and consolidation system 320 is able to characterize or identify this new node quickly.

Once this identification is done, asset categorization and consolidation system 320 adds the asset to the corresponding cluster and evolves the system at two levels:

1. Every time a new asset is added to a cluster, system 320 evolves the set of attributes that contribute to the mean calculation corresponding to that cluster using any new knowledge that this asset might provide.

2. Periodically (fixed/variable time windows), system 320 performs an overall re-clustering to reorganize overall clusters and patterns.

FIG. 7 is a block diagram illustrating a mechanism for mapping a new requirement in accordance with an illustrative embodiment. Asset categorization and consolidation system 320 receives new requirement 701 and translates the requirement (if not already specified) into terms of equivalent attributes that govern the “mean” of various clusters. Once specified, the “requirement mean” is computed following the exact weighting scheme used during clustering. Once these computations are done, asset categorization and consolidation system 320 maps new requirement 320 simply by calculating the cluster with the mean value closest to the “requirement mean,” thus resulting in the requirement being mapped to the category of assets 730.

Once asset categorization and consolidation system 320 finds a duster that represents the sample of assets that can satisfy the given requirement 701, asset categorization and consolidation system 320 examines assets in that cluster to deduce the best match (or a list of matches) and presents the list on a UI for an administrator to approve. Once approval is completed, asset categorization and consolidation system 320 deploys the asset to the requirement location and updates the duster, if required, or annotates the assets in the cluster with what assets are available and what assets are reserved.

As will be appreciated by one skilled in the art, aspects of the present invention may be embodied as a system, method, or computer program product. Accordingly, aspects of the present invention may take the form of an entirety hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be a system, apparatus, or device of an electronic, magnetic, optical, electromagnetic, or semiconductor nature, any suitable combination of the foregoing, or equivalents thereof. More specific examples (a non-exhaustive list) of the computer readable storage medium would include the following: an electrical device having a storage capability, a portable computer diskette, a hard disk, a random access memory (RAM), a read-only memory (ROM), an erasable programmable read-only memory (EPROM or Flash memory), an optical fiber based device, a portable compact disc read-only memory (CDROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

In some illustrative embodiments, the computer readable medium is a non-transitory computer readable medium. A non-transitory computer readable medium is any medium that is not a disembodied signal or propagation wave, i.e. pure signal or propagation wave per se. A non-transitory computer readable medium may utilize signals and propagation waves, but is not the signal or propagation wave itself. Thus, for example, various forms of memory devices, and other types of systems, devices, or apparatus, that utilize signals in any way, such as, for example, to maintain their state, may be considered to be non-transitory computer readable media within the scope of the present description.

A computer readable signal medium, on the other hand, may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Similarly, a computer readable storage medium is any computer readable medium that is not a computer readable signal medium.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection my be made to an external computer (for example, through the Internet using an Internet Service Provider).

Aspects of the present invention are described below with reference to flowchart illustrations and/or block diagrams of methods, apparatus (systems and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

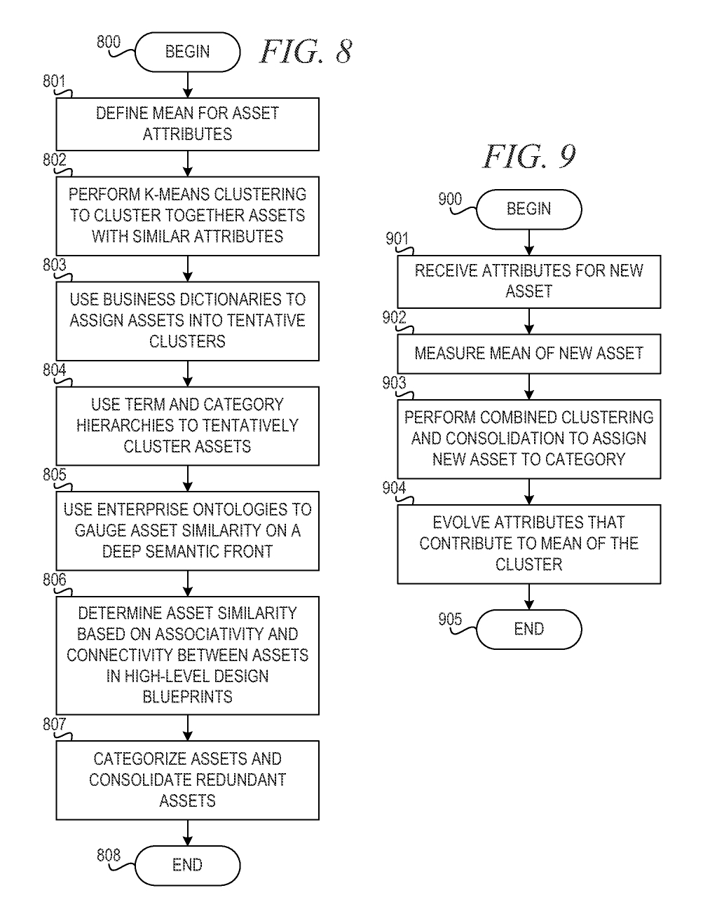

FIG. 8 is a flowchart illustrating operation of a mechanism for asset categorization and consolidation in accordance with an illustrative embodiment. Operation begins (block 800), and the mechanism defines a mean for attributes of IT assets (block 801). The mechanism performs k-means clustering to cluster together assets with similar attributes (block 802). The mechanism then uses business dictionaries to assign assets into tentative categories (block 803). The mechanism also uses term and category hierarchies to tentatively cluster assets (block 804).

The mechanism then uses enterprise ontologies to gauge asset similarity on a deep semantic front (block 805). The mechanism determines asset similarity based on associativity and connectivity between assets in high-level design blueprints (block 806). Then, the mechanism categorizes the assets and consolidates redundant assets based on the results of the k-means clustering, the clustering based on business dictionaries and category hierarchies, the enterprise ontologies, and the high-level design blueprints (block 807). Thereafter, operation ends (block 808).

FIG. 9 is a flowchart illustrating operation of a mechanism for categorizing anew asset in accordance with an illustrative embodiment. Operation begins (block 900), and the mechanism receives attributes for a new asset (block 901). The mechanism measures the mean of the new asset (block 902). The mechanism then performs combined clustering and consolidation to assign the new asset to a cluster or category (block 903). Then, the mechanism evolves the attributes that contribute to the mean of the cluster (block 904). Thereafter, operation ends (block 905).

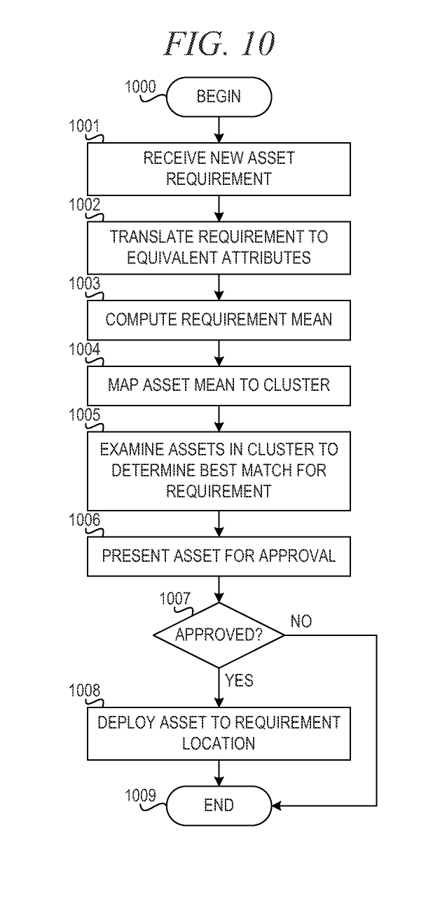

FIG. 10 is a flowchart illustrating operation of a mechanism for mapping a new requirement in accordance with an illustrative embodiment. Operation begins (block 1000), and the mechanism receives now asset requirement (block 1001). The mechanism translates the requirement to equivalent attributes as the asset clusters determined for the IT landscape (block 1002). The mechanism computes a requirement mean (block 1003) and maps the asset mean to a cluster (block 1004).

The mechanism then examines the assets in the cluster to determine a best match or matches for the requirement (block 1005). The mechanism presents the asset(s) to a user for approval (block 1006) and determines whether the user approves an asset for the requirement (block 1007). If the user approves an asset for the requirement, the mechanism deploys the asset to the requirement location (block 1008). Thereafter, operation ends (block 1009). If the user does not approve an asset for the requirement in block 1007, operation ends (block 1109).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based. systems that perform the specified functions or acts, or combinations of special purpose hardware and computer instructions.

The illustrative embodiments improve understanding of the IT asset landscape and improve the ability to detect redundant assets. The illustrative embodiments also reduce the time and labor required to understand IT assets in a large and/or complex IT landscape. The illustrative embodiments also remove errors in classifying IT assets.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for categorization of assets, the method comprising:
receiving attribute values for a set of information technology (IT) assets;
performing k-means clustering analysis to cluster together IT assets with similar attributes to form a set of asset clusters;
using a knowledge representation associated with the set of IT assets to assign the IT assets into a set of tentative clusters; and
categorizing the set of IT assets into categories based on a combination of the set of asset clusters and the set of tentative clusters.

2. The method of claim 1, wherein performing k-means clustering comprises defining a mean taking into consideration attributes that define the set of IT assets.

3. The method of claim 2, wherein defining a mean comprises weighing the attributes based on a predefined weighing scheme.

4. The method of claim 1, wherein using a knowledge representation to assign the IT assets into a set of tentative clusters comprises using a business dictionary to identify IT assets assigned to the same or similar terms and marking the identified IT assets in tentative clusters.

5. The method of claim 4, wherein using the knowledge representation to assign the IT assets into the set of tentative clusters further comprises using existing hierarchies in the business dictionary to tentatively cluster assets even if they are not directly linked to the same term.

6. The method of claim 1, further comprising:
using an enterprise ontology graph to determine asset similarity.

7. The method of claim 6, wherein using the enterprise ontology graph to determine asset similarity comprises identifying tentative clusters based on semantic relationships.

8. The method of claim 1, further comprising:
using a high-level design blueprint to deduce asset similarity based on associativity and connectivity between assets in the high-level design blueprint.

9. The method of claim 1, further comprising:
receiving a new IT asset;
determining a mean for the new asset; and
performing a combination of k-mean clustering analysis and knowledge representation analysis to assign the new IT asset to an identified category.

10. The method of claim 9, further comprising:
updating attributes that contribute to the mean of the identified category.

11. The method of claim 1, further comprising:
receiving a new asset requirement;
translating the new asset requirement to equivalent attributes;
determining a requirement mean; and
mapping the requirement mean to an identified cluster.

12. The method of claim 11, further comprising:
examining IT assets in the identified cluster to determine a best match asset for the new asset requirement;
presenting the best match asset to a user for approval;
responsive to the user approving the best match asset, deploying the best match asset to a requirement location associated with the new asset requirement.

13. A computer program product comprising a computer readable storage medium having a computer readable program stored therein, wherein the computer readable program, when executed on a computing device, causes the computing device to:
receive attribute values for a set of information technology (IT) assets;
perform k-means clustering analysis to cluster together IT assets with similar attributes to form a set of asset clusters;
use a knowledge representation associated with the set of IT assets to assign the IT assets into a set of tentative clusters; and
categorize the set of IT assets into categories based on a combination of the set of asset clusters and the set of tentative clusters.

14. The computer program product of claim 13, wherein using a knowledge representation to assign the IT assets into a set of tentative clusters comprises using a business dictionary to identify IT assets assigned to the same or similar terms and marking the identified IT assets in tentative clusters.

15. The computer program product of claim 13, wherein the computer readable program further causes the computing device to:
use an enterprise ontology graph to determine asset similarity.

16. The computer program product of claim 13, wherein the computer readable program further causes the computing device to:
use a high-level design blueprint to deduce asset similarity based on associativity and connectivity between assets in the high-level design blueprint.

17. The computer program product of claim 13, wherein the computer readable program further causes the computing device to:
receive a new IT asset;
determine a mean for the new asset; and
perform a combination of k-mean clustering analysis and knowledge representation analysis to assign the new IT asset to an identified category.

18. The computer program product of claim 13, wherein the computer readable program further causes the computing device to:
receive a new asset requirement;
translate the new asset requirement to equivalent attributes;
determine a requirement mean; and
map the requirement mean to an identified cluster.

19. An apparatus comprising:
a processor; and
a memory coupled to the processor, wherein the memory comprises instructions which, when executed by the processor, cause the processor to:
receive attribute values for a set of information technology (IT) assets;
perform k-means clustering analysis to cluster together IT assets with similar attributes to form a set of asset clusters;
use a knowledge representation associated with the set of IT assets to assign the IT assets into a set of tentative clusters; and
categorize the set of IT assets into categories based on a combination of the set of asset clusters and the set of tentative clusters.

20. The apparatus of claim 19, wherein using a knowledge representation to assign the IT assets into a set of tentative clusters comprises using a business dictionary to identify IT assets assigned to the same or similar terms and marking the identified IT assets in tentative clusters, wherein the instructions further cause the processor to:
use an enterprise ontology graph to determine asset similarity; and
use a high-level design blueprint to deduce asset similarity based on associativity and connectivity between assets in the high-level design blueprint.
